(19) United States
(12) Patent Application Publication
(10) Pub. No.: US 2015/0215395 A1
(43) Pub. Date: Jul. 30, 2015

(54) SYSTEM AND CONTROL METHOD

(71) Applicant: CANON KABUSHIKI KAISHA, Tokyo (JP)

(72) Inventor: Hirotaka Funayama, Kawasaki-shi (JP)

(21) Appl. No.: 14/596,920

(22) Filed: Jan. 14, 2015

(30) Foreign Application Priority Data
Jan. 29, 2014 (JP) 2014-014822

(51) Int. Cl. H04L 29/08

(52) U.S. Cl. CPC H04L 67/1008

(57) ABSTRACT

A system 102 receives a file and multiple savings of the file from an external device 101 which has requested a file saving, and an information processing apparatus 1401 saves the file, and then repeats processing for instructing another information processing apparatus 1401 that should subsequently save the file to save the file in an amount equivalent to the multiple savings.

### BACKGROUND OF THE INVENTION

1. Field of the Invention

This invention is related to a system for saving a file and a control method therefor.

2. Description of the Related Art

In a system for multiply saving a file, there has been proposed a technique for saving a file requested to be saved to a file server with a low load. Japanese Patent Laid-Open No. 2000-207370 discloses a technique for regularly reporting load information of the file server itself by each server to another server and identifying the server with the low load by referring to the load information when saving the file to save the file to the server with the low load.

Here, an information processing system for receiving a file and multiple savings is assumed. This information processing system is, for example, a system for receiving a file and multiple savings from a client and saving the received file to a plurality of file servers with the instructed multiple savings to improve availability of the server.

When the file server for saving the file according to the multiple savings is determined according to the technique disclosed by Japanese Patent Laid-Open No. 2000-207370, the following problems may occur. Specifically, in Japanese Patent Laid-Open No. 2000-207370, each file server reports a loaded state to a management server, and the file is saved to the server with a low load. If there are many files to be saved and the like, it is necessary to shorten the reporting intervals due to the intense change in the load of each file server. However, if the reporting intervals are too short or the number of the file servers is large, the load may be concentrated on the management server.

### SUMMARY OF THE INVENTION

This invention provides an information processing apparatus for efficiently a file save processing without concentrating a load on a network or single apparatus as far as possible.

According to a system of the present invention, a system comprising an external device and a plurality of information processing apparatuses, wherein the external device comprises: a distributing unit configured to distribute a file saving request to the plurality of information processing apparatuses in request units and perform the file saving request to a single information processing apparatus, wherein the single information processing apparatus comprises: a saving unit configured to save a file of the request to the single information processing apparatus; and an instructing unit configured to repeat processing for instructing the information processing apparatus that should subsequently save the file among the plurality of information processing apparatuses to save the file based on multiple savings.

Further features of the present invention will become apparent from the following description of exemplary embodiments (with reference to the attached drawings).

### BRIEF DESCRIPTION OF THE DRAWINGS

FIG. 1 illustrates an exemplary configuration of an overall cloud system according to an embodiment of the present invention.

FIGS. 2A and 2B illustrate a hardware configuration of a client terminal and a server computer.

FIG. 3 illustrates the software configuration of a scan server.

FIG. 4 illustrates a series of sequence diagrams of scan processing.

FIG. 5 illustrates a software configuration of a task server.

FIG. 6 illustrates a software configuration of a flow server group.

FIG. 7 illustrates a configuration of an overall file management service server group.

FIG. 8 illustrates a software configuration of a file management service.

FIGS. 9A and 9B illustrate an example of file management server information and file path information.

FIG. 10 is a flow chart representing a flow of a determination of a priority.

FIG. 11A to 11C illustrate an example of processing for saving a file.

FIG. 12A to 12D illustrate an effect acquired by the present invention.

FIG. 13 is an example of priority information according to a second embodiment.

FIG. 14 is a flow chart illustrating a flow of the determination of the priority according to the second embodiment.

FIG. 15 is a flow chart illustrating a flow of processing when a failure occurs.

FIG. 16A to 16D illustrate an event in a third embodiment.

FIG. 17 is an example of file management server information according to the third embodiment.

FIG. 18 is a flow chart when an error occurs in the third embodiment.

FIG. 19 is a flow chart when an error occurs in a fourth embodiment.

### DESCRIPTION OF THE EMBODIMENTS

Firstly, as a product of replications of the file, for example, a description will be given of a function for creating a replication in a Distributed File System (®) (hereinafter, referred to as “DFS”) from Microsoft (hereinafter, referred to as a “DFS replication function”). When a user uses the DFS replication function, the user registers a plurality of servers beforehand in an Active Directory (®) (hereinafter, referred to as “AD”). Then, the DFS replication function is used to manually create a replication rule, such as “replicate a file saved in a server A to a server B” and share the rule between all of the servers via an AD server to enable replicating the file. However, if one apparatus fails, the DFS replication function does not dynamically switch a replication address to reduce the number of replications of the file. As a result, the file cannot be saved with the instructed multiple savings to reduce the availability of the server. To solve the above problem, it is necessary not to fix a replication rule and to dynamically select a saving address server of the file from among the operating servers.

However, a bottleneck may be caused by the algorithm if the saving address server is dynamically selected and the performance of the server is reduced. The following, for example, can be considered as a selection algorithm for the saving address server:

(1) a method for selecting a server with less capacity from among the operating file servers; and

(2) a method for selecting a server at random from among the operating file servers.

In method (1), the used capacity of each server can be equally distributed to use the file server efficiently. In contrast, it is necessary to manage the capacity of all files and the saving address thereof with a database or the like and calculate how much the files are saved and which file server is saved every time the file is saved. Also, if the file server is scaled out, the file is saved intensively and a disk I/O is intensively performed since there are fewer files in the server immediately after the scale out compared to the other servers.

In method (2), a load is concentrated to some extent since access to the database is generated only in acquiring the operating server. Thus, the level of the load is less than that in the method (1). Also, if a network load, a CPU, and a memory are taken into account, although the access is equally distributed to each server in the long run, the load can be concentrated on one server at an instant. Accordingly, since the bottleneck is generated no matter which algorithm of the method (1) or (2) is selected, the occurrence of the bottleneck can cause a reduction in the performance of the system. Hereinafter, a description will be given of a configuration that enables resolving such an event.

In an aspect for performing each process at the server computer side, there has been proposed techniques such as a cloud computing system or SaaS (Software as a Service). Also, in cloud computing, it is possible to simultaneously process requests from many clients by utilizing numerous computing resources, and by conducting distributed execution of data conversion and data processing. In addition, to fully utilize this feature of cloud computing, the present specification considers a method for implementing a series of processes on the server by connecting finely defined tasks, and simultaneously processing the tasks in parallel to scalably process a large number of jobs.

Here, the “task” refers to processing content comprising a job or a process on the software to implement the processing content in the present specification. In this case, a temporary file that should be processed by a task at the head and a temporary file generated as a result of the processing in each task are considered to create the replication to a plurality of file servers to assure the availability of the system in a job processor.

A job management service server that controls a job comprising one or more task(s), information related to the job, a job execution order, and the like are contemplated. Each task can start up a plurality of respective instances. In addition, each instance asynchronously acquires the job from the job management service server, and performs, for example, image processing such as black dot removal, or a process of storing data to a shared folder. A file management service server group manages binary data to be processed by each task. Each task acquires data to be processed from the file management service server group as needed and saves a processing result. The data input to the file management service server group as a result of the task processing is called “data resulting from task processing” in the present specification. Also, the data is information included in the file. In the present specification, an application for inputting the job to the job management service server is called a “service application”.

The service application inputs the job to the job management service server, while the data to be processed is input to the file management service server group. The data input to the file management service server group at the same time as the job input is called “initial data” in the present specification. Also, the data is information included in the file.

The initial data and the data resulting from the task processing are saved to the plurality of file servers to retrieve the data after being saved. Thereby, even if a failure or the like is generated in the server, the initial data and the data resulting from the task processing can be retrieved to improve the availability of the system by restarting the processing based on the initial data.

However, one or more of the database, the network, the CPU or the disk I/O is (are) determined to be the bottleneck depending on the saving address selection algorithm when saving the file to the plurality of file servers. Thereby, the performance of the temporary file management service server group can be reduced. In the examples described below, a description will be given of a method for selecting the saving address of the file without reducing the performance of the system.

### First Embodiment

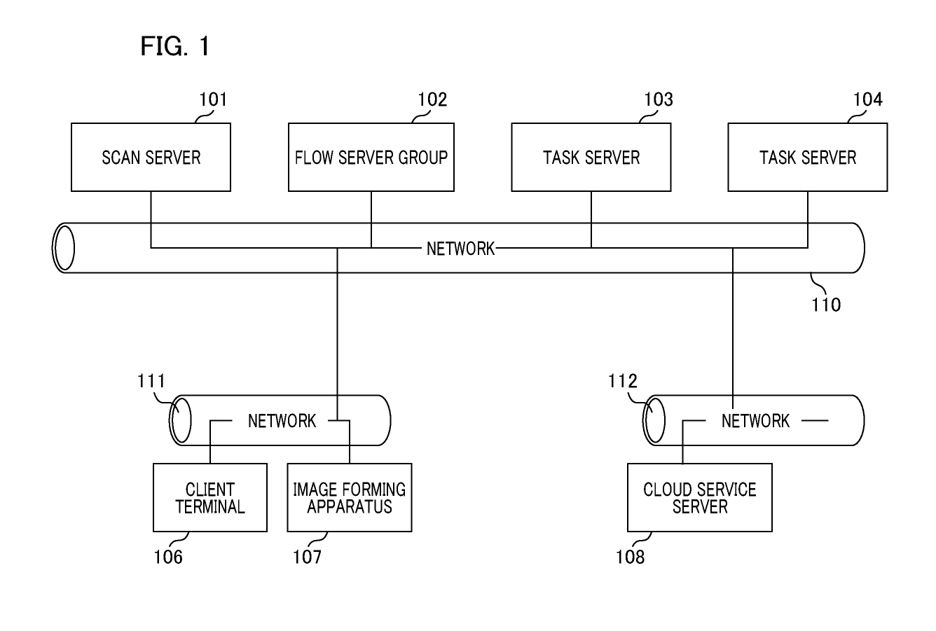

FIG. 1 illustrates a configuration of an overall information processing system according to an embodiment of the present invention. The information processing system of the present embodiment is a cloud system that provides an image processing service to a user of a client terminal 106. The information processing system in FIG. 1 comprises a scan server 101, a flow server group 102, task servers 103 and 104, the client terminal 106, an image forming apparatus 107, and a cloud service server 108.

The configuration as shown in FIG. 1 is intended to be an example, and it is assumed that a plural number of each of the task servers 103 and 104, the client terminal 106, the image forming apparatus 107, and the cloud service server 108 that are connected to a network. From the scan server 101 to the task server 104, there is a communicable connection via a network 110. The client terminal 106 and the image forming apparatus 107 are communicably connected from the scan server 101 to the task server 104 via a network 111 and the network 110. Also, the cloud service server group 108 is communicably connected from the scan server 101 to the task server 104 via a network 112 and the network 110.

The networks 110 to 112 are referred to as “communication networks” implemented, for example, by any of a LAN, WAN, telephone circuitry, dedicated digital circuitry, ATM or frame relay circuitry, cable television circuitry, data broadcasting wireless circuitry of the Internet and the like, or a combination thereof. The LAN stands for “Local Area Network”. The WAN stands for a “Wide Area Network”. The ATM stands for an “Asynchronous Transfer Mode”.

The networks 110 to 112 may be communication networks implemented by the combination of the LAN to the data broadcasting wireless circuitry as described above. Specifically, the networks 110 to 112 can transmit/receive the data. In this example, because the information processing system of the present embodiment is the cloud system, the networks 110 and 112 are the Internet, and the network 111 is a network within a corporation or a network of a service provider.

The scan server 101, the flow server 102, and the task servers 103 and 104 are executed on the server computer by a virtual server, and these service server groups provide a cloud service to the user. Also, the cloud service server 108 is publicly available on the Internet, and the cloud service server 108 is also executed on the server computer.

Hereinafter, each function of the server in the present specification may be realized by single server or single virtual server, or by a plurality of servers or a plurality of virtual servers. Alternatively, the plurality of servers may be executed as the virtual server on single server.

The client terminal 106 comprises, for example, a desktop personal computer, a notebook personal computer, a mobile personal computer, a PDA (personal data assistant), or the like. However, the client terminal 106 may also be a mobile phone incorporating a program execution environment. The client terminal 106 incorporates an environment in which a program such as a Web browser (an internet browser, a WWW browser, a browser provided for World Wide Web use) is executed.

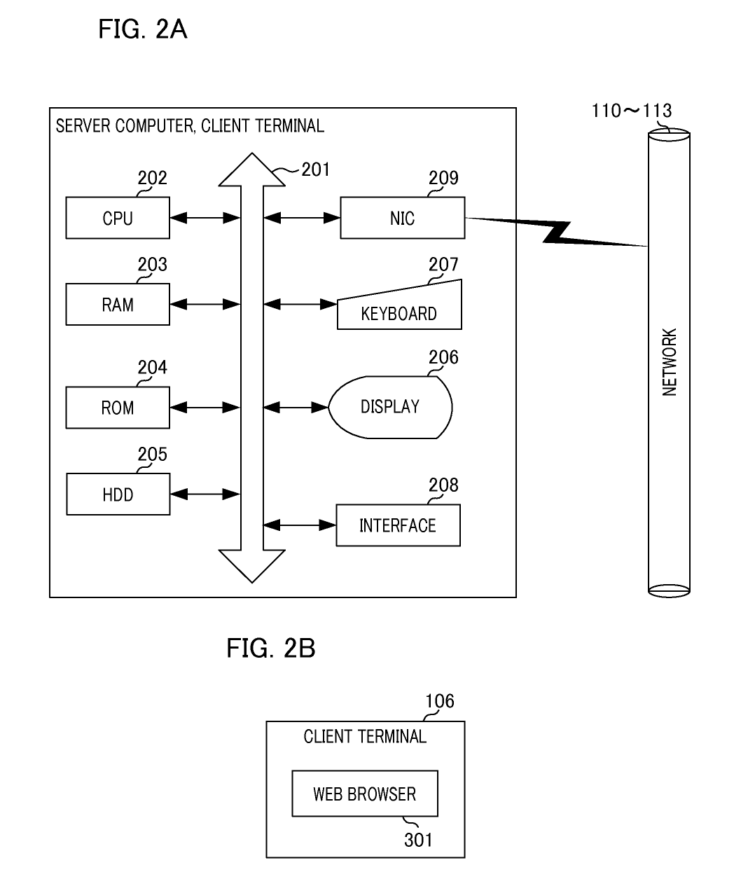

FIG. 2A illustrates an exemplary configuration of the hardware of the server computer that realizes the client terminal, the scan server, the flow server group and the task server. The client terminal 106 and the server computer comprise a CPU 202, a RAM 203, a ROM 204, and a HDD 205. The CPU stands for a “Central Processing Unit”. The RAM stands for a “READ Access Memory”. The ROM stands for a “READ Only Memory”. The HDD strands for a “Hard Disk Drive”. Also, the client terminal 106 and the server computer comprise a NIC 209, a keyboard 207, a display 206, and an interface 208. The NIC stands for a “Network Interface Card”.

The CPU 202 controls entire apparatus. The CPU 202 executes an application program, OS and the like stored in the HDD 205, and controls the information and the file and the like that is required in the execution of the program to be stored temporarily in the RAM 203. The OS stands for an “Operating System”. The ROM 204 is a storing unit configured to store each type of data such as a basic I/O program. The RAM 203 is a temporary storing unit configured to function as a main memory of the CPU 202, work area or the like. The HDD 205 is one of external storing units configured to function as a large-capacity memory and store application programs such as Web browsers, service group programs, OS, related programs, and the like.

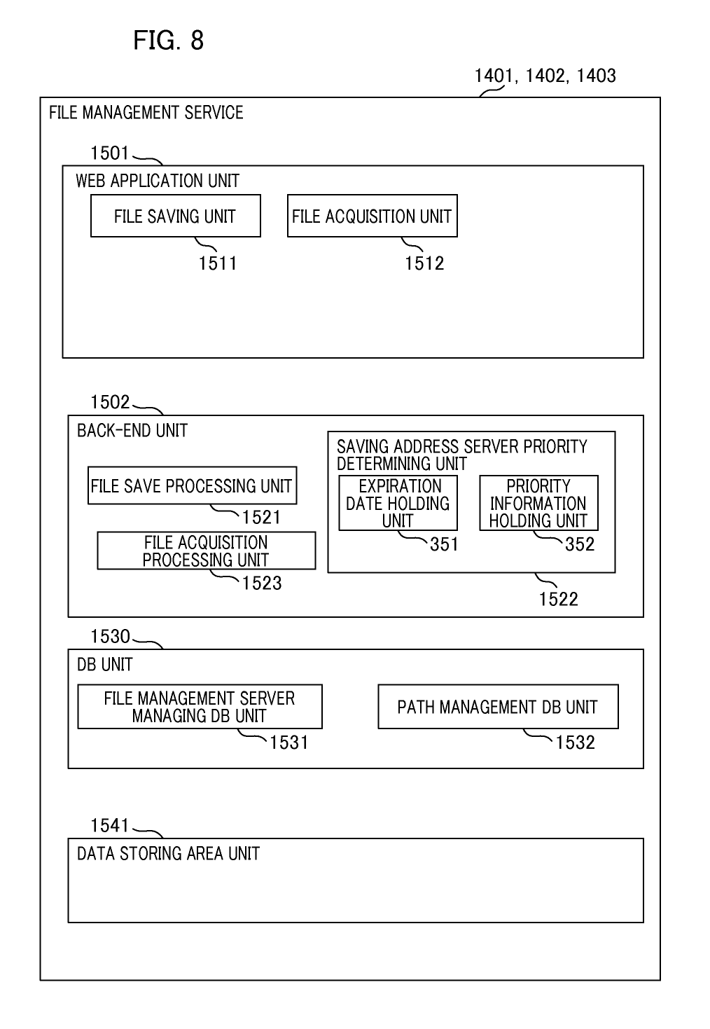

The display 206 is a displaying unit configured to display a command and the like input from the keyboard 207. The interface 208 is an external device I/F, and connects a printer, USB equipment, and peripheral equipment. The keyboard 207 is an instruction inputting unit. A system bus 201 conducts the flow of the data within the apparatus. The CPU 202 to the interface 208 is connected to the system bus 201. The NIC 209 exchanges the data to the external device via the interface 208 and the networks 110 to 112. Note that the configuration of the apparatus as shown in FIG. 2A is intended to be an example and not to limit the configuration example of FIG. 2A. For example, the storage destination of data and programs may be any one of the ROM 204, the RAM 203, and the HDD 205 according to the characteristics thereof. The CPU 202 executes the processing based on the program stored in the HDD 205 to realize a software configuration as shown in FIG. 8 or the like and processing in each step of a flow chart as described below.

FIG. 2B illustrates an exemplary configuration of a client terminal. The client terminal 106 comprises a Web browser 301. The Web browser 301 transmits a request to a Web application provided by the scan server 101 (FIG. 1), and displays a response and the like. The user using the cloud service uses the Web browser 301 of the client terminal 106 to use the cloud service.

Next, a description will be given of the scan server 101, the flow server group 102, the task servers 103 and 104 that provide the cloud service.

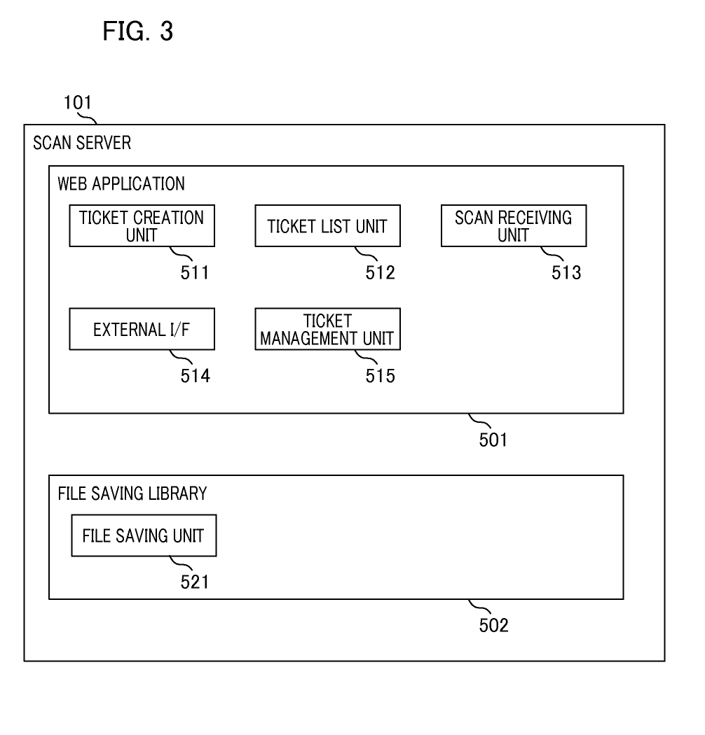

FIG. 3 illustrates an exemplary configuration of software of the scan server 101. The scan server 101 is a service that provides a scan function in the cloud service. The scan server 101 comprises a Web application 501 and a file saving library 502. These components execute each type of processing to provide a scan service to the user.

The Web application 501 provides an application program that provides a scan function. A ticket creation unit 511 realizes a series of functions to create a scan ticket by the user. The scan ticket records a setting during the scan of a manuscript with the image forming apparatus 107, a definition of a subsequent processing flow, a parameter for a task performed in each processing flow, and the like.

An external I/F 514 communicates to a scan software unit (not shown) that operates on the image forming apparatus 107. From the scan software unit, access to a function of a ticket list unit 512 and a scan receiving unit 513 is performed via the external I/F 514. The ticket receiving unit 512 generates a ticket list based on ticket information saved in a ticket management unit 515 and returns the generated list to the image forming apparatus 107 in accordance with the request from the image forming apparatus 107.

The file saving library 502 is a library used when saving data to the flow server group 102. The detail description thereof will be described as below. The scan receiving unit 513 receives the scan ticket and the image data from the image forming apparatus 107. Then, the scan receiving unit 513 transmits the received scan ticket and the image data to a file saving unit 521.

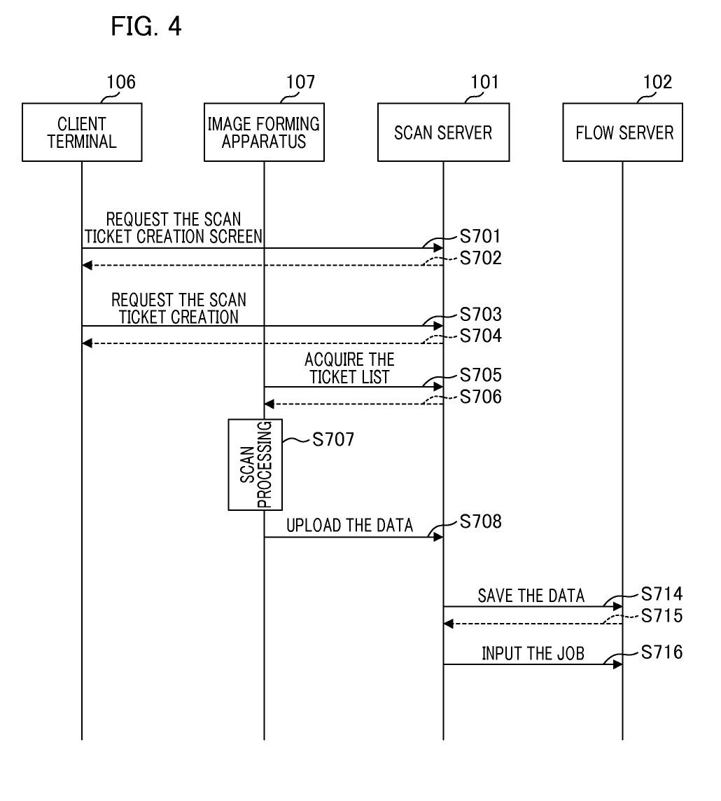

Next, a description will be given of the flow until an input of the scan job as illustrated in FIG. 4. Firstly, a description will be given of the creation of the scan ticket and the flow until the input of the scan job in the scan processing. In S701, the ticket creation unit 511 receives a scan ticket creation screen request from the Web browser 301 of the client terminal 106, and in S702, generates a scan ticket creation screen and performs a response. In S703, the user performs an operation by using the Web browser 301 of the client terminal 106 and performs a scan ticket creation request. Thereby, the user requests the scan ticket creation and the saving of the created scan ticket to the ticket management unit 515. After saving the ticket information, the ticket management unit 515 returns the response in S704.

In S705, the scan software unit of the image forming apparatus 107 performs acquisition of the ticket list to the ticket list unit 512 via the external I/F 514. The image forming apparatus 107 may be an apparatus with functions of both the scan and the print, and may also be a dedicated scan apparatus with function of only the scan. The ticket list unit 512 generates a list of the scan ticket by using the ticket management unit 515 and returns the generated ticket list to the scan software unit as a response. The image forming apparatus 107 receiving the response displays the acquired ticket list on the user interface.

In S707, the user selects any of the tickets displayed on the user interface of the image forming apparatus 107 and places a paper in a scan device equipped with the image forming apparatus 107 to carry out the scan. Thereby, the scan software unit transmits the scanned image data and the scan ticket to the scan receiving unit 513 via the external I/F 514 (S708).

In S714, the scan server 101 transmits the received image data to the flow server group 102 and requests saving the data. In this processing, the file saving unit 521 inputs the file information including the multiple savings to the flow server group 102, together with the image data. The file information is described as below. Thereby, the file management service server group 803 of the flow server group 102 receives the file (the image data in the present embodiment) and the file information related to the file.

After receiving the image data correctly, the flow server group 102 responses with an ID (a file group ID) uniquely representing the image data to the scan server 101 in S715. Then, in S716, the scan receiving unit 513 transmits the file group ID, the scan ticket, a tenant ID, and the multiple savings as the job information to the flow server group 102. In the processing, the tenant ID is an ID to which the user who inputs the job belongs and is unique to the tenant. The above processing describes the system configuration of the scan server 101 and the flow until the input of the scan job.

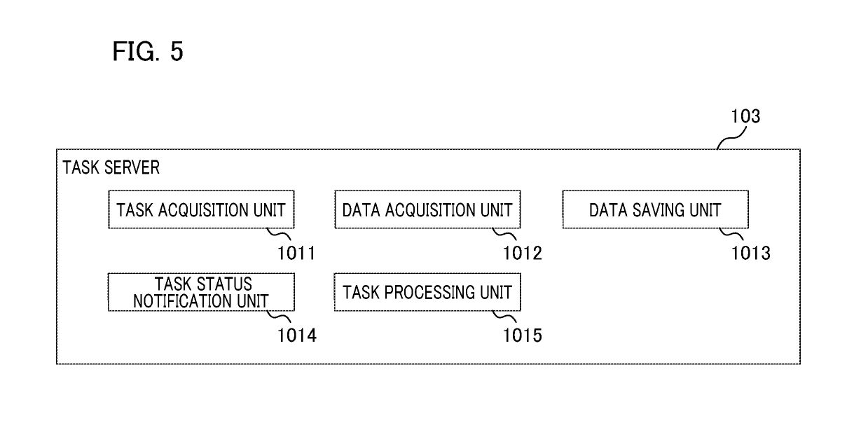

FIG. 5 illustrates an exemplary configuration of the task server. In this example, a description will be given of a configuration of the task server 103. The configuration of the task server 104 is similar to that of the task server 103. The task server 103 performs OCR processing on the image data and processing that embeds the text data of the OCR result in the image data. Also, the task server 104 performs processing for uploading and storing the image data to the certain service that provides the storage function in the cloud service server group 108.

As shown in FIG. 5, the task server 103 comprises a task acquisition unit 1011, a data acquisition unit 1012, a data saving unit 1013, a task status notification unit 1014, and a task processing unit 1015. The task acquisition unit 1011 periodically issues inquiries to the flow service server group 102 to acquire a task asynchronously that can be processed in the task server 103. The data acquisition unit 1012 acquires image data to be processed from the flow service server group 102 based on the task information acquired by the task acquisition unit 1011. The task processing unit 1015 performs a variety of processing with respect to the image data acquired by the data acquisition unit 1012. Also, the task processing unit 1015 delivers the processing results of the task processing unit 1015 to the data saving unit 1013. The data saving unit 1013 saves the processing results received from the task processing unit 1015 to the flow service server group 102. The task status notification unit 1014 periodically provides a status notification to the flow server group 102. The status notification is a notification indicating that the task server is in the state of the task processing.

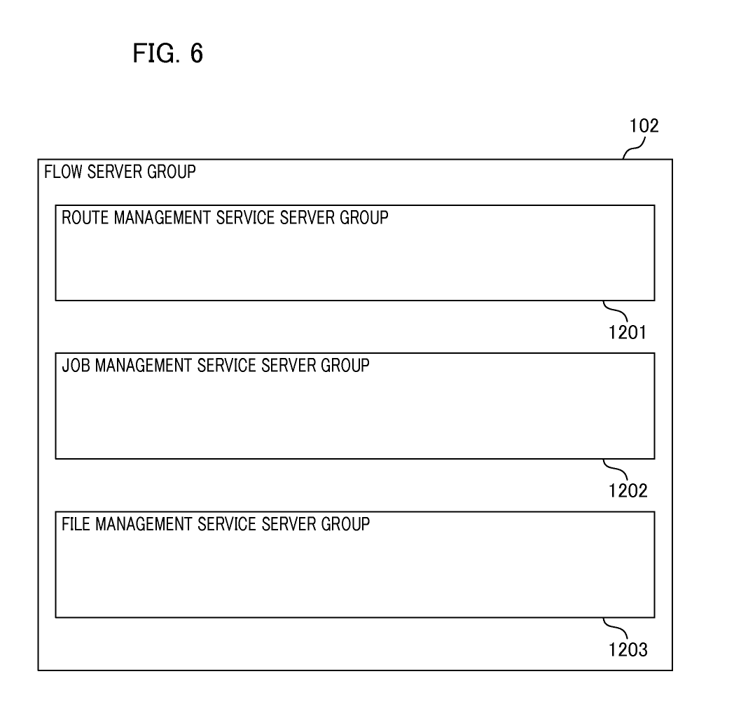

FIG. 6 illustrates an exemplary configuration of the flow service server group. The flow service server group 102 is a service server group for performing route management, job management, and file management. The flow service server group 102 comprises a route management service server group 1201, a job management service server group 1202, and a file management service server group 1203. The route management service server group 1201 manages route information. The job management service server group 1202 manages the processing of the job based on the route information.

The file management service server group 1203 manages saving of data present at the time of the job input and data resulting from the respective task processing. More specifically, the file management service server group 1203 stores a file depending on a request from the scan server and 101 and the task servers (103, 104), and manages a path to the storage destination of the file. If the task server requires the file acquisition, the scan server 101 returns binary data of the saved file to the task server. Also, if the task server or the job management service server group 1202 requests the deletion of the file, the file management service server group 1203 deletes the saved file. By using the function of the temporary file management service server group 1203, the scan server 101 and the task server can perform file saving, acquisition, and deletion irrespective of the path to the file storage destination or the status of the file server.

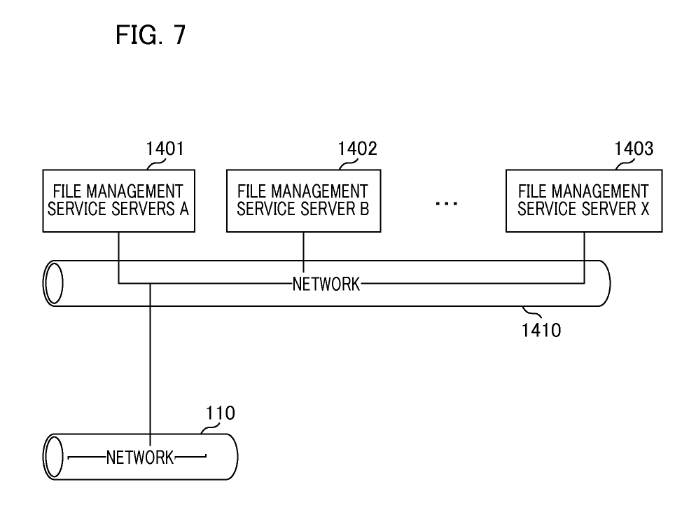

Next, a description will be given of the file management service server group 1203. FIG. 7 illustrates a configuration of the overall file management service server group 1203 that functions as an information processing apparatus according to an embodiment of the present invention. File management service servers A1401 to X1403 as shown in FIG. 7 are connected each other via a network 1410. The number of the file management service servers A1401 to X1403 may be any one of a natural number. Also, the network 1410 is connected to the network 110. The network 1410 is a communication network that enables transmitting/receiving data similar to that in the network 110.

Note that the file management service servers A1401 to X1403 may be implemented as virtual servers on one or more server computer(s). If the servers are implemented as the virtual servers on the one server computer, the network 1410 is implemented by a system bus on the server computer.

Next, referring to FIG. 8, a description will be given of the file management service servers A1401 to X1403 that provide a function for managing the temporary file. The configurations of each of the servers A1401 to X1403 each have a same configuration, and the file management service server A1401 is described as illustrated below. The file management service server A1401 comprises a Web application unit 1501, a back-end unit 1502, a DB unit 1530, and a data storing area unit 1541. The DB unit 1530 comprises a file management server managing DB unit 1531 and a path management DB unit 1532. These configurations execute each type of the processing to provide the file management service. An expiration date holding unit 351 and a priority information holding unit 352 are not used in a first embodiment, and thus these units are described in the second embodiment as following.

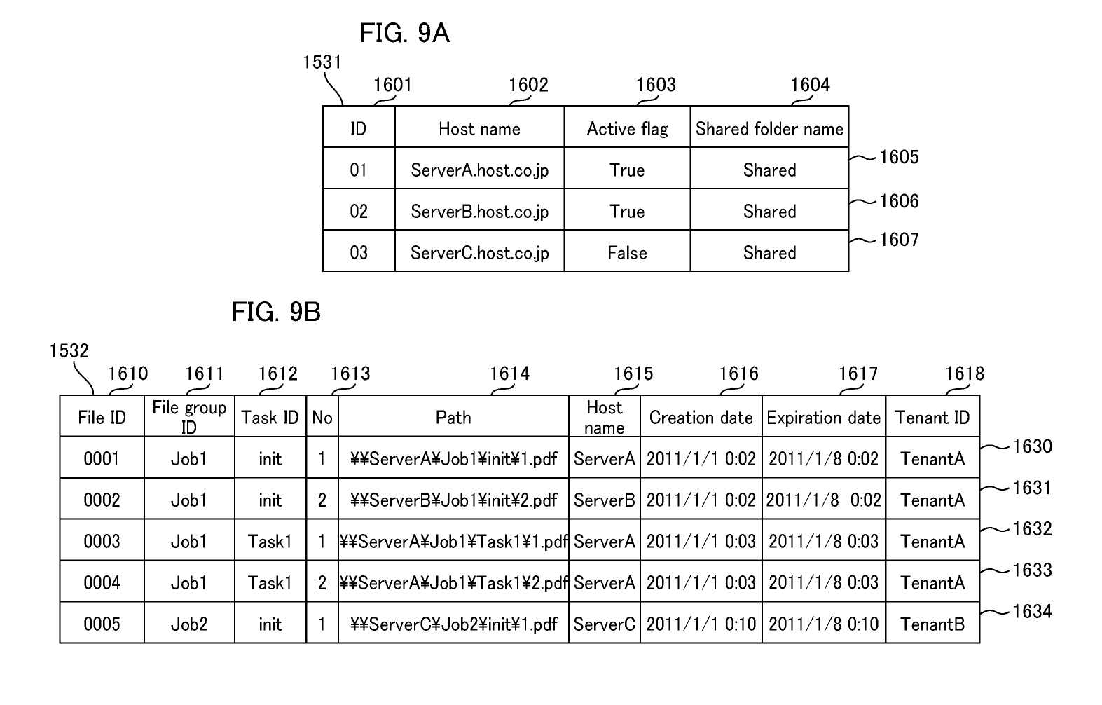

The file management server managing DB unit 1531 manages information about the file management service servers A1401 to X1403, which are storage destinations of the file. Also, the file management server managing DB unit 1531 receives a request from a saving address server priority determining unit 1522 and accesses a DB common to each server to acquire information about the file management service server while start-up. FIG. 9A illustrates an example of data managed by the DB unit 1531. ID 1601 is information to uniquely identify the file management service server within a file management service server group 803. A host name 1602 illustrates a unique address of the file management service server on the network 1410. An active flag 1603 is a true/false value representing whether the file management service server existing in the host name 1602 can be connected or not, and if the server can be connected, the value is “True” and if the server cannot be connected, the value is “False”. A shared folder name 1604 is a folder that is present on the file management service servers A1401 to X1403. The data storing area unit 1541 represents the folder referred by the shared folder name 1604.

The path management DB unit 1532 manages information about a temporary file saved in the data storing area unit 1541 of the file management service servers A1401 to X1403 as an entry managed by the file management service server group 803. The temporary file refers to a file of the initial data saved from the scan server 101 and the result of the task processing saved from the task servers 103 and 104.

FIG. 9B illustrates an example of the entry managed by the path management DB unit 1532. A file ID 1610 is information for uniquely identifying the entry in the file management service servers A1401 to X1403. A file group ID 1611 is information for grouping each entry with a job associated therewith. Accordingly, the entries generated by the same job have the same file group ID 1611. A task ID 1612 provides a task ID for identifying a task associated to the temporary file corresponding to each entity, or a value of an “init” representing the initial data. NO1613 refers to a file number of the temporary file generated by each task. In the present embodiment, NO1613 is accorded to any number by the scan server 101.

A path 1614 refers to a full path of the storage destination of the temporary file corresponding to each entry and is used in accessing the entity via the back-end unit 1502 by the Web application unit 1501. A host name 1615 refers to a host name of the file management service server for the storage destination of the temporary file corresponding to each entry. A creation date 1616 refers to a time when the storage of the temporary file to the data storing area unit 1541 is completed. An expiration date 1617 refers to an expiration date of the temporary file, and the temporary file corresponding to the entry is deleted if the expiration date of the temporary file is passed. A tenant ID 1618 refers to a tenant ID of a tenant to which the user saving the temporary file belongs.

Next, a description will be given of each function of the Web application unit 1501. The Web application unit 1501 comprises a file saving unit 1511 and a file acquisition unit 1512. The file saving unit 1511 implements a function for multiplexing a file with the instructed multiple savings and saving the file to the data storing area unit 1541 depending on the request from the scan server 101 or the task servers 103 and 104. The request from the scan server or the task servers 103 and 104 comprises information related to the saved file, such as a task ID 1612 and NO1613, the expiration date 1617, and the tenant ID 1618, which are managed as the entry of the path management DB unit 1532. As a whole, the above information is called “file information” in the present specification.

Next, a description will be given of each function of the back-end unit 1502. The back-end unit 1502 comprises a file save processing unit 1521, a file acquisition processing unit 1523, and a saving address server priority determining unit 1522. From the scan server 101 or the task servers 103 and 104, the file save processing unit 1521 receives a file saving request via the file saving unit 1511. The file save processing unit 1521 that receives the request performs an acquisition request for the priority of the file management service server to which the data storage area unit 1541 that is set as the file saving address to the saving address server priority determining unit 1522 belongs. In the present specification, the file management service server to which the data storage area 1541 that is set as the saving address of the file belongs is called a “file saving address server”.

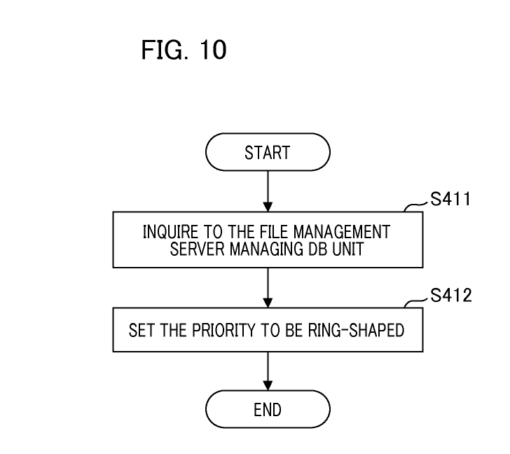

FIG. 10 is a flow chart illustrating a flow for determining a priority of the file saving address server. From the file management server managing DB unit 1531, the saving address server priority determining unit 1522 receiving the request acquires the file saving address server for which the active flag 1603 is “True” in S411. Next, in S412, the saving address server priority determining unit 1522 sets the priority from the file saving address server list acquired in S411 to be ring-shaped. A method for determining the priority to be ring-shaped is described as below. After determining the priority, the saving address server priority determining unit 1522 responses the priority of the file saving address server to the file save processing unit 1521.

Next, the file save processing unit 1521 extracts the file saving address server to the amount equivalent to the instructed multiple savings starting from the higher priority of the file saving address servers, and writes a file to the data storing area unit 1541. Then, the file save processing unit 1521 adds the entry performing the file writing to the path management DB unit 1532. Finally, the file save processing unit 1521 responds to the scan server 101 or the task servers 103 and 104, which are request sources, with a notification of the normal save via the file saving unit 1511.

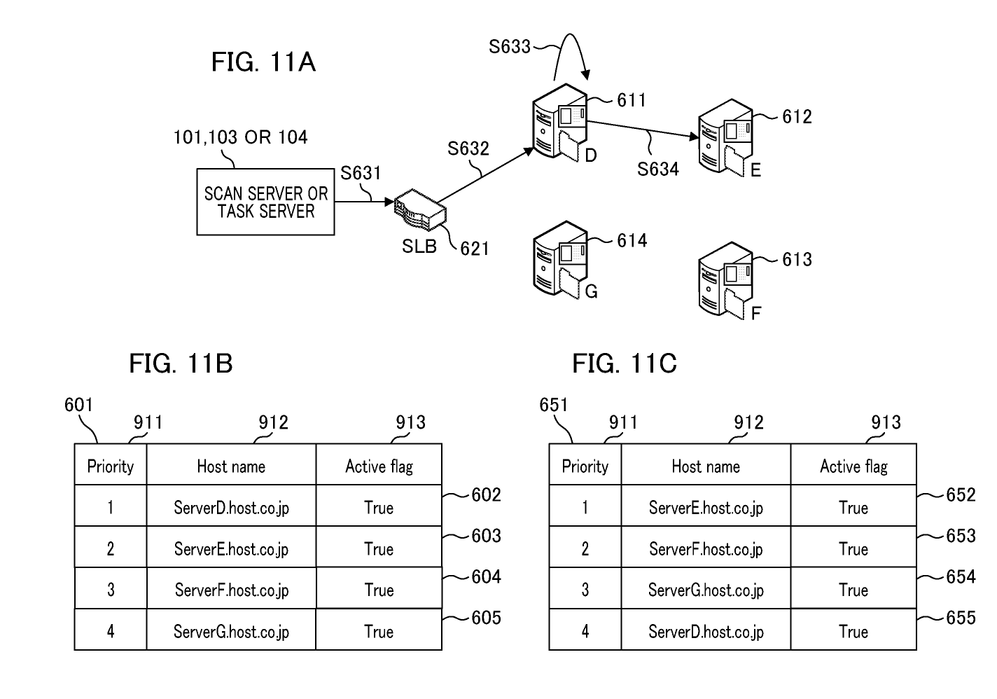

Referring to FIG. 11A to 11C, a description will be given of a flow of the file save processing and a concrete example of a method for determining that the priority is ring-shaped. In this example, a case is supposed in which four servers among the file management servers D611 to G614 are operated as the file management server group. Also, a saving request from the scan server 101 or the task servers 103 and 104 to the temporary file management service server group is distributed to each file management service server in request units in a round-robin system by SLB621. In addition, it is supposed that the saving request is to two of the multiple savings.

In S631 of FIG. 11A, the saving request is transmitted from the scan server 101 or the task servers 103 and 104 to SLB621, which is a load balancer. In S632, SLB621 transmits the saving request to the file management service server D611. In S633, the file management server managing DB 1531 of the file management service server D611 receives the request from the saving address server priority determining unit 1522 and acquires information about the file management service server during the startup. The information comprises an order of the arrangement for the plurality of information preprocessing apparatuses during the startup. The saving address server priority determining unit 1522 of the file management service server D611 acquires the order of the arrangement for the plurality of information preprocessing apparatuses during the startup and identifies the server itself as the information processing apparatus that first saves the file. Then, the saving address server priority determining unit 1522 identifies the priority of the information processing apparatus that saves the file as the server itself is a criterion. FIG. 11B illustrates an example of priority information 601.

A priority 911 is used in determining the file saving address server by the file save processing unit 1521. A host name 912 is a host name of the file saving address server corresponding to the priority 911. An active flag 913 is a true/false value illustrating whether or not the connection to the file management service server that exists in the host name 912 can be performed, and if the connection can be performed, the value is set as “True” and if the connection cannot be performed, the value is set as “False”. In this example, the priority 911 sets the ID 1601 to be an “own server, a server larger than the own server (ascending order), a sever smaller than the own server (descending order)” from the higher priority (smaller priority 911) of the file saving address server. ID 1601 is used in determining the priority, but any one may be used even if all of the file management service servers are included.

After determining the priority, the file save processing unit 1521 on the file management service server D611 performs file save processing S633 to the file management service server D611 of the priority 1. Next, the file save processing unit 1521 performs file save processing to a file management service server E612 of the priority 2. (S634). In the file save processing, the file management service server D611 receiving the saving request instructs that the file be saved to the file management service server E612. Accordingly, if the multiplicity is three, the file management service server D611 instructs that the file be saved to the file management servers E612 and E613. Thereby, constant processing in which the file management server D611 saves a file, and then instructs another file management service server in which the file should be saved after that to save the file is repeated just in an amount equivalent to the multiple savings. Note that considering a communication error and the like, the present embodiment may be configured to wait for a notification of file saving completion from a file management service server E612, and transmit the saving instruction to the file management service server F613.

FIG. 11C illustrates an example assuming that the saving request is distributed to the file management service server E612 in S631. Priority information 651 is priority information determined by the saving address server priority determining unit 1522 of the file management service server F613 at this time.

The priority information 601 and the priority information 651 comprise all of the file management service servers D611 to G614 and are determined to shift the priority one by one respectively. A description of the priority will be omitted for the case in which the file saving request is distributed to the file management service server F613 or G614 by SLB 621. Also, all of the file management servers D611 to G614 are included in the present embodiment. Additionally, the priority is determined to be shifted one by one respectively. The term “ring-shaped” in “determine the priority to be ring-shaped” denotes a circle of the file management server E612→F613→G614→D611→E612 . . . When the priority “1” of the file management service server is determined, the priority is automatically determined in the order of this circle.

Since the load can be concentrated in one file saving address server if two or more priorities are shifted, or initially, the order is random, depending on a distribution address of the file saving request 631, and preferably, the priority is shifted one by one.

Referring back to FIG. 8, a description will be given of file acquisition processing. The file acquisition processing 1523 receives a file acquisition request via the file acquisition 1512 and from the task servers 103 and 104. When the file acquisition processing unit 1523 receives the file acquisition request, it searches for an entry corresponding to the file information in the request from the path management DB unit 1532. The file acquisition processing unit 1523 acquires the corresponding temporary file from the data storage area and returns the temporary file to the task servers 103 and 104 via the file acquisition 1512, which are the request sources if there is an entry corresponding to the request in the path management DB unit 1532.

A first effect of the first embodiment is that the reduction of the performance due to the occurrence of a bottleneck can be prevented even if the file saving is required from the scan server 101 or the task servers 103 and 104.

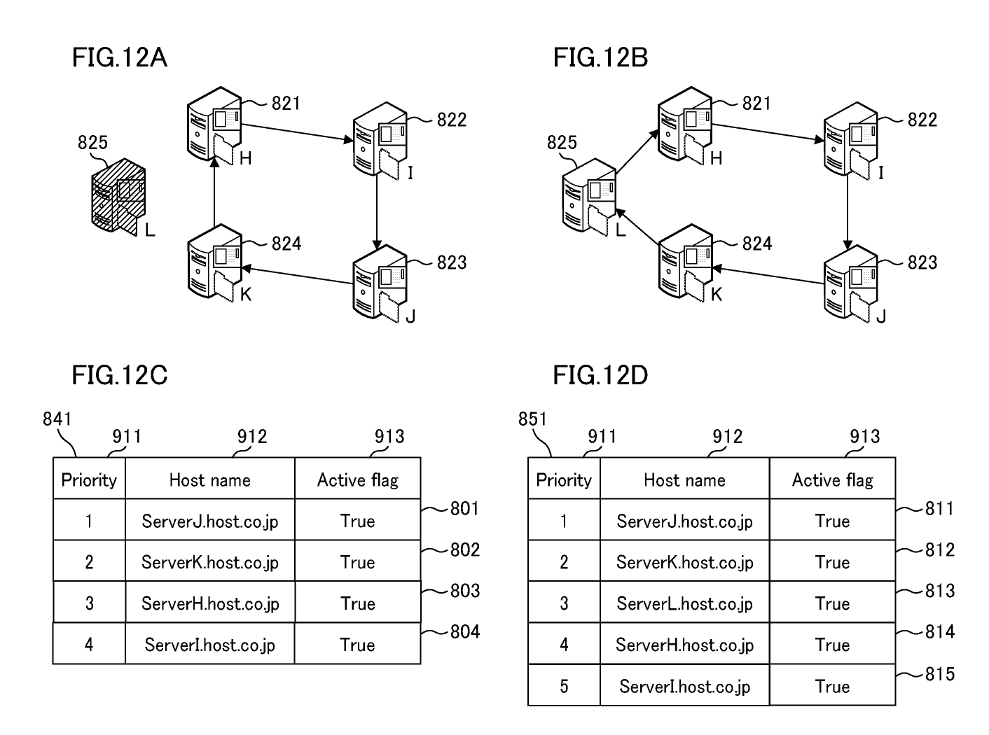

A description will be given of a second effect due to the first embodiment referring to FIG. 12A-12D. A case is supposed in which file management service servers H821 to L825 are operated as file management service server groups. Note that FIG. 12A illustrates an example in which only the file management service server L825 has stopped due to a failure. Also, priority information determined in the saving address server priority determining unit 1522 of a file management service server J823 at this time is priority information 841. In contrast, FIG. 12B illustrates an example of a state in which the file management service server L825 has recovered from the failure state as illustrated in FIG. 12A. At this time, the priority information determined in the saving address server priority determining unit 1522 of the file management service server J823 is priority information 851.

When the file management service server L825 has recovered from the failure, the processing transits from FIG. 12A to FIG. 12B, or the scale out is executed, and the file management service server L825 only has to be added along the ring of the priority information 841. Also, if the file management service server is increased by the scale out, the server in which the increase has occurred has only to be input along the circle. Thereby, the second effect due to the first embodiment is that the recovery or the scale out of the file management service server can be performed easily.

### Second Embodiment

In the first embodiment, a case is supposed in which a large number of file saving requests are executed from the scan server 101 or the task servers 103 and 104 to the file saving unit 1511. At this time, a large number of the priority acquisition requests are generated to the saving address server priority determining unit 1522. Specifically, access is concentrated on the file management server managing DB for managing a startup state and a non-startup state in each apparatus. Therefore, the load on the database is increased, and the performance of the server is reduced.

When via the file saving unit 1511, the file save processing unit 1521 receives the file saving request from the scan server 101 or the task servers 103 and 104, a difference between the second embodiment and the first embodiment is the method for determining the priority of the saving address server priority determining unit 1522. In the second embodiment, a description will be given of a method for determining the priority of the file saving address server by the saving address server priority determining unit 1522.

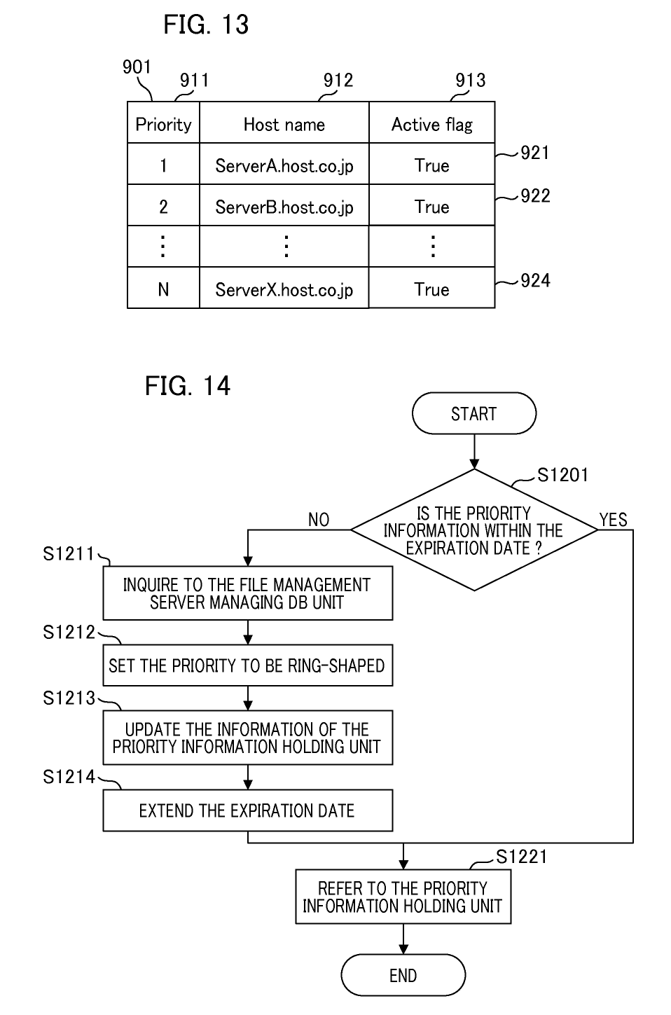

FIG. 13 illustrates the priority information held by the priority information holding unit 352. The priority information holding unit 352 holds priority information 901 on a memory and the expiration date holding unit 351 holds an expiration date of the priority information 901 held in the priority information holding unit 352. Specifically, the priority information holding unit 352 and the expiration date holding unit 351 manage the priority of the information processing apparatus storing the file using a validity period. In the first embodiment, the priority information 901 is cleared depending on each file saving request. In contrast, the priority information 901 is not cleared for each saving processing and is held in the priority information holding unit 352 in the second embodiment.

Next, referring to the flow chart as shown in FIG. 14, a description will be given of a procedure for determining the priority by the saving address server priority determining unit 1522. When the saving address server priority determining unit 1522 receives a priority acquisition request from the file save processing unit 1521, the following steps are performed in S1201. Specifically, the saving address server priority determining unit 1522 confirms whether or not the priority information held on the memory in the priority information holding unit 352 is within the period held in the expiration date holding unit 351.

If the priority information has not been determined to be within the expiration date in S1201, similar to the first embodiment, in S1211, the saving address server priority determining unit 1522 acquires the file saving address server for which the active flag 1603 is “True” from the file management server managing DB unit 1531. Next, in S1212, the saving address server priority determining unit 1522 sets the priority to be ring-shaped from the file saving address server list acquired in S1211.

Then, in S1213, the saving address server priority determining unit 1522 updates the priority information held in the memory by the priority information holding unit 352 to the priority information set in S1212, and the expiration date of the expiration date holding unit 351 is extended in S1214. For example, the expiration date is updated to the time 1 minute after the current time and the like. After S1214 or if the processing is determined to be within the expiration date in S1210, the file save processing unit 1521 returns as-is the priority information 901 held on the memory in the priority information holding unit 352.

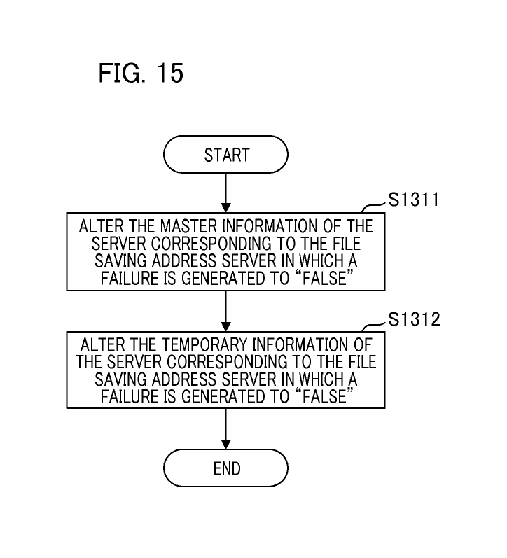

Next, a description will be given of processing in a case that an error occurs on the file saving operation from the file save processing unit 1521 to the file saving address server and the processing fails, referring to the flow chart of FIG. 15. In the present specification, the active flag 1603 of each file saving address server held in the file management server managing DB unit 1531 is called “master information”. The active flag 913 held in the priority information holding unit 352 is called “temporary information”.

Also, the case in which the error occurs denotes a case in which the file save processing unit 1521 cannot save the file to the file saving address server due to the occurrence of the failure in, for example, the file saving address server. If the file save processing unit 1521 cannot save the file to the information processing apparatus except for the information processing apparatus with the file save processing unit 1521, the information processing apparatus that cannot save the file is set so as to be in a non-startup state, and the image processing apparatus that is set so as to be in the non-startup state is excluded from the arrangement order. More specifically, when an error is generated during the file saving, the file save processing unit 1521 determines that a failure has been generated in the file saving address server to which the file is intended to be saved. Then, in S1311, the file save processing unit 1521 alters the master information of the server corresponding to the file saving address server in which the failure is generated to “False”. Furthermore, the file save processing unit 1521 alters the temporary information of the server corresponding to the file saving server in which the failure is generated to “False” via the saving address server priority determining unit 1522 in S1312.

As described above, even if the file saving request to the file saving unit 1511 is concentrated, the saving address server priority determining unit 1522 does not always refer to the file management server managing DB unit 1531 if it is within the expiration date. Accordingly, an effect acquired by the second embodiment is that the request can be executed without the bottleneck of the file management server managing DB unit 1531.

### Third Embodiment

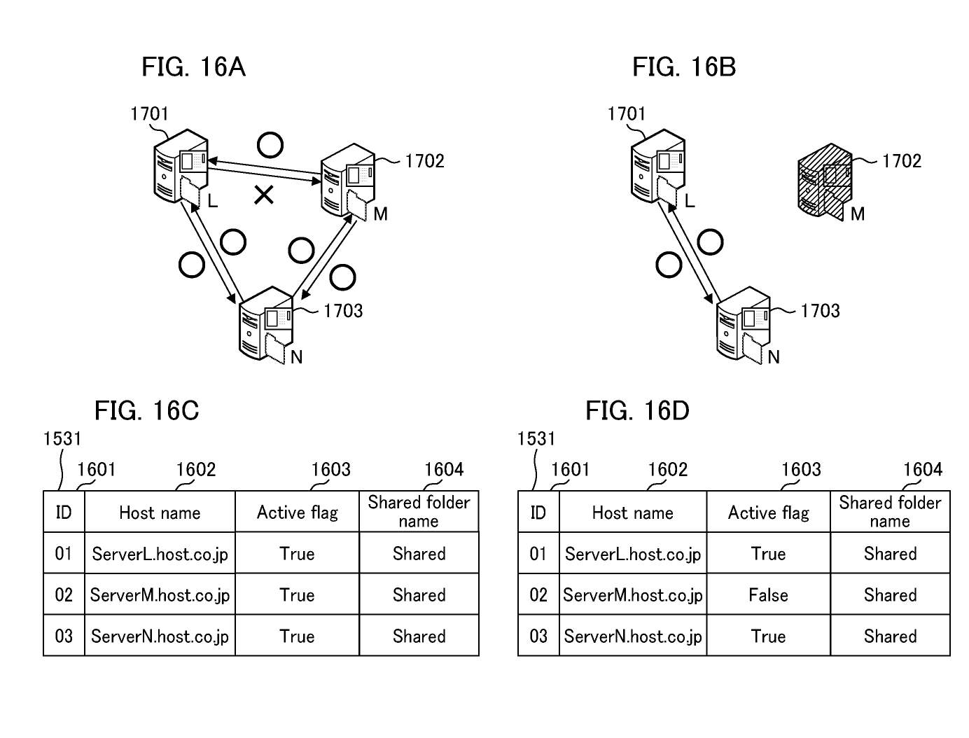

In the second embodiment, a case is supposed in which only a connection between a certain file management service server and another file management service server is not possible. For example, the case comprises a case as shown in FIG. 16A. FIG. 16A illustrates a situation in which file management service servers L1701 to N1703 are operating. This situation illustrates an example in which a setting of the firewall is wrong, which causes a disconnection between the file management service server L1701 and a file management service server M1702. Specifically, in FIG. 16A, marks o and marks x respectively illustrate whether a connection between the file management service servers in the direction of arrows can be executed or not.

FIG. 16C illustrates a state of the file management server managing DB unit 1532 shown in FIG. 16A, and a state that all servers are operated. In this state, if the processing is executed according to the processing if the processing fails as described in the second embodiment, the file management service server M1702 is set to be in the non-startup state. More specifically, only the save from the file management service server L1701 to the file management service server M1702 cannot be executed to cause the active flag of the file management service server M1702 to be “False”. FIG. 16D illustrates the state of the file management server managing DB unit 1531 during the above processing, and FIG. 16B illustrates a communication state between each file management service server. As a result, the processing causes an increase in the load of the file management service servers M1702 and N1703, and a pressing storage capacity of the data storing area unit 1541.

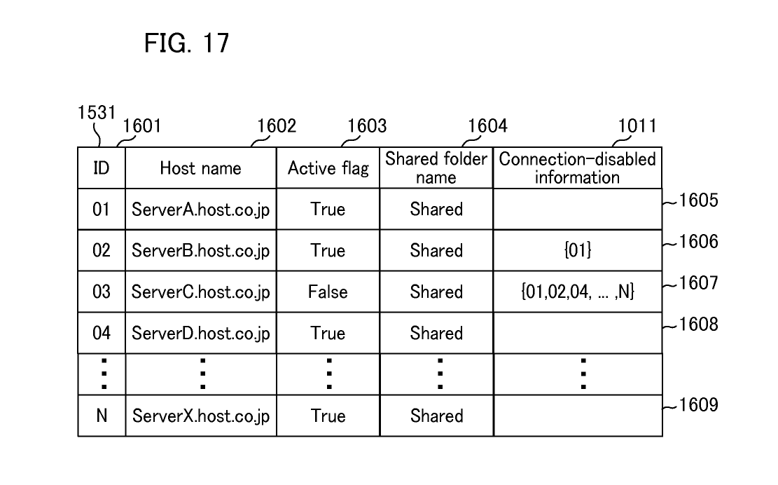

FIG. 17 is an example of information held by the file management server managing DB unit 1531 according to an example of the present invention. Connection-disabled information 1011 associates an ID (identification information) of the file management service server that fails the file storage to the datastoring area unit 1541 of the corresponding file management service server, and holds the ID with values separated by a comma. In the present embodiment, the above event is solved by using this connection-disabled information 1011.

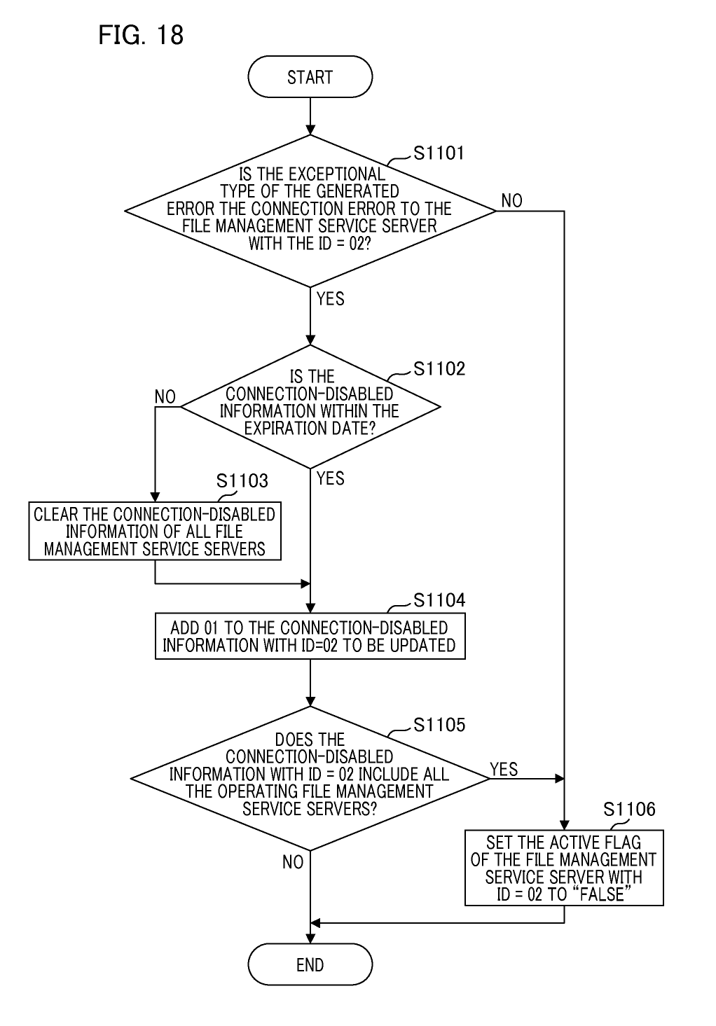

FIG. 18 is a flow of processing in a case in which a file storage from a file management service server to another file management service server fails. In FIG. 18, a description will be given of processing in a case in which storage from the file save processing unit 1521 on the file management service server A1401 (ID1601 is 01) to the file storing area unit 1541 on the file management service server B1402 (ID1601 is 02) fails. When the file save processing unit 1521 detects the occurrence of an error, the file save processing unit 1521 determines the type of the generated error in S1101. In S1101, if the exceptional type of the error is a communication error, the file save processing unit 1521 determines whether or not the connection-disabled information 1011 is within the expiration date in S1102. The communication error stands, for example, for a time out and the like. The file management server managing DB unit 1531 holds the expiration date of the connection-disabled information 1011 (not shown in the present embodiment).

If the connection-disabled information 1011 is determined to be beyond the expiration date in S1102, the file save processing unit 1521 clears the connection-disabled information 1011 of all the file management service servers in S1103. The reason for the clearing is that only the master information of the file management service server that has been determined to be “unconnected” from all servers within the certain period (expiration date) is set to be “False”.

After S1103, or in S1102, if the connection-disabled information 1011 is determined to be within the expiration date, 01 is added to the connection-disabled information 1011 of the file management service server B1402 for which the ID 1601 is 02 in S1104. This processing illustrates a failure of the file saving to the file storing area unit 1541 of the file management service server B1402 from the file save processing unit 1521 of the file management service server A1401 due to the occurrence of the communication error.

Next, the file save processing unit 1521 determines whether the connection-disabled information 1011 of the file management service server B1402 in which the ID 1602 is 02 in S1105 comprises all of the operating file management service servers. In S1105, if the file save processing unit 1521 determines that the connection-disabled information 1011 does not comprise all of the operating management service servers, the processing is stopped. If the file save processing unit 1521 determines that the connection-disabled information 1011 comprises all of the operating management service servers in S1105 and is not a communication error in S1101, the processing proceeds to S1106. In 51106, the file save processing unit 1521 alters the master information of the file management service server B1402 in which the ID1602 is 02 to “False”.

In the third embodiment, only the connection from a certain file management service server to another file management service server cannot be executed. However, if another file management service server is operating, the master information can be prevented from being altered to be “False”.

### Fourth Embodiment

In the third embodiment, irrespective of the operation of the file management service server, the master information can be prevented from being altered to “False”. However, for example, if the connection to the file management service server B1402 cannot be executed because the setting of the firewall for the file management service server A1401 is wrong due to operation mistake, an operator cannot provide notification about the operation mistake.

So, in the fourth embodiment, character strings held in the connection-disabled information 1011 are set to connect “ID1601”: “a number of times for the generation of the error, except for writing” with the comma separated value for each file management service server as {01:10,02:5,03:4, . . . ,N:7}. Then, if the number of times for the generation of the writing error to one or more file management service server(s) exceeds a threshold within the expiration date of the connection-disabled information 1011, the file save processing unit 1521 outputs an error log.

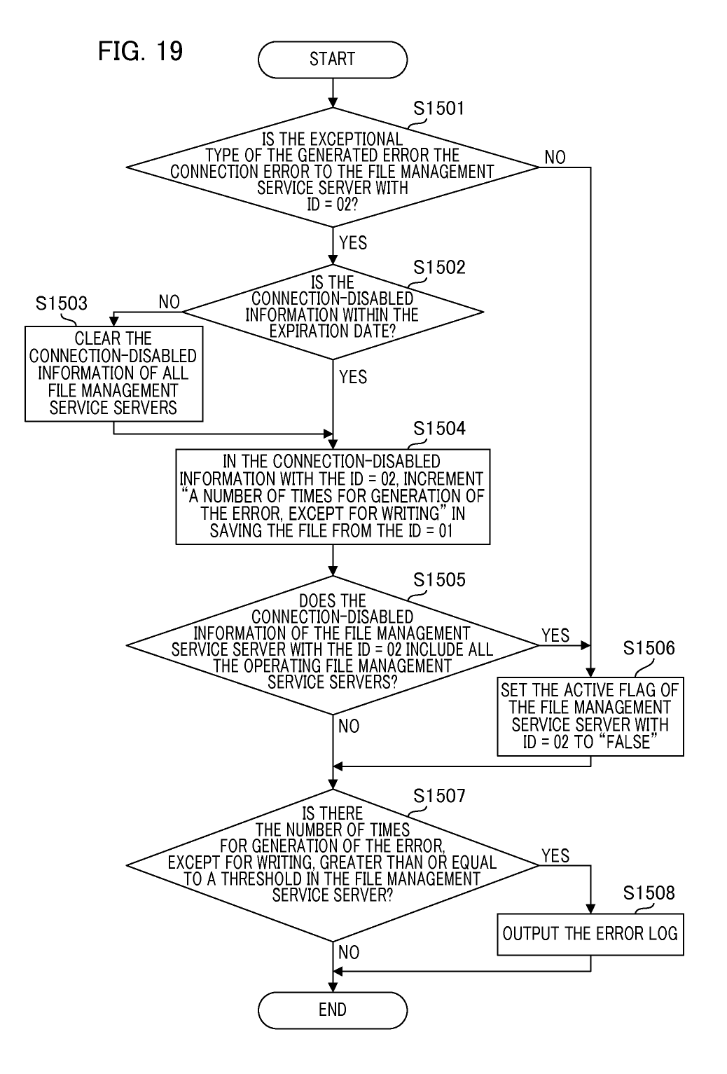

FIG. 19 illustrates a flow of processing in the case in which a storage of the file from a certain file management service server to another file management service server has failed. In the processing, an example of failed processing is illustrated for the storage from the file save processing unit 1521 on the file management service server A1401 (ID 1601 is 01) to the file storing area unit 1541 on the file management service server B1402 (ID1601 is 02). S1501 to S1503, S1505 and S1506 are similar to S1101 to S1103, S1105 and S1106 in FIG. 18 as illustrated in the third embodiment, and thus, a description thereof will be omitted.

In S1504, the file save processing unit 1521 performs the processing in the connection-disabled information 1011 of the file management service server B1402 in which the ID 1601 is 02 as described below. The file save processing unit 1521 performs an increment for a number of times for the generation of the error, except for the writing, when it saves the file from the file management service server A1401 in which the ID1601 is 01. For example, the connection-disabled information 1011 is incremented from {01:1} to {01:2}. Next, in S1507, the file save processing unit 1521 determines whether or not there is a server with a number of times for the generation of the error, except for the writing, greater than or equal to a threshold, during the writing from a certain file management service server to another certain file management service server. If the server with the number of times for the generation of the error, except for the writing, greater than or equal to the threshold is present in S1507, the file save processing unit 1521 outputs the error log in S1508.

According to the fourth embodiment, the error log is output even if the connection to the file management service server B1402 cannot be executed because the setting for the firewall of the file management service server A1401 is wrong due to, for example, an operation mistake. Accordingly, notification about the operation mistake can be provided to the user by monitoring the error log.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-014822, filed Jan. 29, 2014, which is hereby incorporated by reference herein in its entirety.

What is claimed is:

1. A system comprising an external device and a plurality of information processing apparatuses,
wherein the external device comprises:
a distributing unit configured to distribute a file saving request to the plurality of information processing apparatuses in request units and perform the file saving request to a single information processing apparatus,
wherein the single information processing apparatus comprises:
a saving unit configured to save a file of the request to the single information processing apparatus; and
an instructing unit configured to repeat processing for instructing the information processing apparatus that should subsequently save the file among the plurality of information processing apparatuses to save the file based on multiple savings.

2. The system according to claim 1,
wherein the system comprises priority information illustrating a priority of the plurality of information processing apparatuses for saving the file,
wherein the instructing unit identifies the information processing apparatus that should subsequently save the file among the plurality of information processing apparatuses according to an order of the priority, and
repeats the processing for instructing the saving of the file, based on the multiple savings.

3. The system according to claim 2, further comprising:
a period managing unit configured to manage the priority of the information processing apparatus saving the file using a validity period.

4. The system according to claim 2, further comprising:
a managing unit configured to manage a startup state of the information processing apparatus saving the file,
wherein, if the information processing apparatus which received the instruction for the saving of the file cannot save the file, the managing unit excludes the information processing apparatus that cannot save the file from the priority information.

5. The system according to claim 4,
wherein the managing unit manages a number of times that the information processing apparatus which received the instruction for the saving of the file cannot save the file,
wherein, if the number of times is greater than or equal to a threshold, the information processing apparatus which received the instruction for the saving of the file is excluded from the priority information.

6. The system according to claim 5,
wherein the managing unit outputs an error log if the number of times is greater than or equal to the threshold.

7. The system according to claim 1,
wherein the external device is a load balancer and the plurality of information processing apparatuses receives a request for the saving of the file in a round robin system via the load balancer.

8. A control method for a system comprising an external device and a plurality of information processing apparatuses, the control method comprising:
distributing, by the external device, a file saving request to the plurality of information processing apparatuses in request units and performing the request for the saving of the file to a single information processing apparatus;
saving a file of the request to the single information processing apparatus by the single information processing apparatus;
instructing, by the single information processing apparatus, to repeat processing for instructing the information processing apparatus that should subsequently save the file among the plurality of information processing apparatuses to save the file based on multiple savings.

9. The control method of the system according to claim 8,
wherein the system comprises priority information illustrating a priority of the plurality of information processing apparatuses saving the file,
wherein, in the instructing, the information processing apparatus that should subsequently save the file among the plurality of the information processing apparatuses is identified according to an order of the priority, and the processing for instructing the saving of the file is repeated, based on the multiple savings.

10. The control method of the system according to claim 9, further comprising:
managing the priority of the information processing apparatus saving the file using a validity period.

11. The control method of the system according to claim 9, further comprising:
managing a startup state of the information processing apparatus saving the file;
wherein, in the managing of the startup state, if the information processing apparatus which received the instruction for the saving of the file cannot save the file, the information processing apparatus that cannot save the file is excluded from the priority information.

12. The control method of the system according to claim 11,
wherein, in the managing of the startup state, a number of times that the information processing apparatus which received the instruction for the saving of the file cannot save the file is managed, and
wherein, if the number of times is greater than or equal to a threshold, the information processing apparatus which received the instruction for the saving of the file is excluded from the priority information.

13. The control method of the system according to claim 12,
wherein, in the managing of the startup state, an error log is output if the number of times is greater than or equal to the threshold.

14. The control method of the system according to claim 8,
wherein the external device is a load balancer and the plurality of information processing apparatuses receives a request for the saving of the file in a round robin system via the load balancer.
